(19) United States
(12) Patent Application Publication
(10) Pub. No.: US 2012/0027940 A1
(43) Pub. Date: Feb. 2, 2012

(54) PROTECTION COATINGS, MANUFACTURING METHOD AND USE THEREOF

(75) Inventor: CHIH-HAO HUANG, Tu Cheng (TW)

(73) Assignee: Cheng Uei Precision Industry Co., LTD., Tu Cheng City (TW)

(21) Appl. No.: 12/848,157

(22) Filed: Jul. 31, 2010

(51) Int. Cl. B05D 3/02; C09D 5/00

(52) U.S. Cl. 427/384; 106/287.24

(57) ABSTRACT

A protection coating, a manufacturing method and a use thereof are provided. The manufacturing method includes (1) mixing tetraethyl orthosilicate with acrylic silane and evenly stirring at room temperature for 0.5-1.5 hours, so as to obtain an inorganic mixture; (2) mixing the inorganic mixture with deionized water and an organic solvent and continuously stirring at room temperature for 48-72 hours, so as to obtain a clear transparent solution A; (3) preparing a solution of nano-scale silica gel by a sol-gel process; and (4) mixing the solution A with the solution of nano-scale silica gel, adding a predetermined amount of benzoyl peroxide into a mixture of the solution A and the solution of nano-scale silica gel, and evenly stirring at the room temperature for 0.5-1 hour, so as to form a protection coatings of the present invention. The protection coating is applicable on a surface of a plastic product.

### FIELD OF THE INVENTION

The present invention relates to a protection coatings, and more particularly to a protection coatings, a manufacturing method and a use thereof.

### BACKGROUND OF THE INVENTION

Nowadays, except for basic needs of electrical functions and performances, the outer surface of consumer electronics (such as outer casings or touch panels of mobile phones, MP4 players and the likes) generally must provide a certain abrasion resistance to increase the added value and service life of products. Generally, engineering plastic material for manufacturing the outer casings or touch panels of the mobile phones and the MP4 players can be selected from polycarbonate (PC), poly(methylmethacrylate) (i.e. PMMA), acrylonitrile-butadiene-styrene copolymer (ABS) and etc. However, the foregoing engineering plastic material has no any abrasion resistance. Generally, under a normal operation condition, the appearances of the manufactured consumer electronics have been seriously worn before the electrical functions of the consumer electronics are broken down, resulting in affecting the appearance of products and lowering the value thereof. For enhancing the abrasion resistance of plastic products, a traditional solution is to directly add inorganic particles of a predetermined ratio into the engineering plastic material, and evenly stirring to form an organic/inorganic composite material which can enhance the abrasion resistance of the entire material by the inorganic particles with higher hardness.

However, the problem of the foregoing solution is that the added ratio of the inorganic particles has an upper limit value in a case that the performance of the engineering plastic material can not be affected. Thus, the abrasion resistance of the engineering plastic material cannot be substantially enhanced.

### SUMMARY OF THE INVENTION

A primary object of the present invention is to provide a protection coating, a manufacturing method and a use thereof, which can solve the shortcomings of the foregoing traditional technology, wherein the protection coatings can form a transparent protection layer with higher hardness and better abrasion resistance on a surface of a plastic product.

To achieve the above object, the manufacturing method of a protection coating according to the present invention comprises the following steps of:

(1) mixing tetraethyl orthosilicate (TEOS) with acrylic silane in a mole ratio of 0.5-1:1, and evenly stirring at the room temperature for 0.5-1.5 hours, so as to obtain an inorganic mixture;

(2) mixing the inorganic mixture of step (1) with deionized water and an organic solvent, and continuously stirring at the room temperature for 48-72 hours, so as to obtain a clear transparent solution A, wherein the mole ratio of acrylic silane and deionized water is 1:5, and the mole ratio of acrylic silane and the organic solvent is 1:5;

(3) preparing a solution of nano-scale silica (i.e. silicon dioxide) gel by a sol-gel process, wherein the silica gel has a particle size of about 8-10 nm; and

(4) mixing the solution A of step (2) with the solution of nano-scale silica gel, adding a predetermined amount of benzoyl peroxide into a mixture of the solution A and the solution of nano-scale silica gel, and evenly stirring at the room temperature for 0.5-1 hour, so as to form a colorless transparent protection coatings of the present invention, wherein the ratio of the volume of the solution of silica gel and the total volume of the solution A and the solution of silica gel is 5-10:100, and wherein the ratio of the weight of benzoyl peroxide and the total weight of the solution A, the silica gel and benzoyl peroxide is 0.1-0.3:100.

A protection coating manufactured by the foregoing manufacturing method of the present invention is also provided.

A use of the foregoing protection coating comprises the following steps of:

(1) applying the protection coatings onto a surface of a plastic product; and

(2) heating the plastic product applied with the protection coatings at 80-100° C. for 0.5-8 hours, so that the protection coating applied on the surface of the plastic product is solidified to form a transparent protection layer.

As described above, the protection coatings of the present invention can be used to form the transparent protection layer with higher hardness and better abrasion resistance.

### DETAILED DESCRIPTION OF THE PREFERRED EMBODIMENTS

The structure and the technical means adopted by the present invention to achieve the above and other objects can be best understood by referring to the following detailed description of the preferred embodiments.

A manufacturing method of a protection coating according to the present invention comprises the following steps of:

(1) mixing tetraethyl orthosilicate (TEOS) with acrylic silane in a mole ratio of 0.5-1:1, and evenly stirring at the room temperature for 0.5-1.5 hours, so as to obtain an inorganic mixture;

(2) mixing the inorganic mixture of step (1) with deionized water and an organic solvent, and continuously stirring at the room temperature for 48-72 hours, so as to obtain a clear transparent solution A, wherein the mole ratio of acrylic silane and deionized water is 1:5, the mole ratio of acrylic silane and the organic solvent is 1:5, and the organic solvent is 99.5% ethanol or isopropanol;

(3) preparing a solution of nano-scale silica (i.e. silicon dioxide, SiO₂) gel by a sol-gel process, wherein the silica gel has a particle size of about 8-10 nm, of which an unlimited embodiment is described, as follows: firstly, mixing 1000 g ethanol with 120 g de-ionized water and 80 g HCl solution with 25% concentration in a room temperature, so as to form a mixture solution; and then measuring the pH value of the mixture solution, wherein the pH value of the mixture solution is controlled to be about 3.9-4.0; next, adding 800 g tetraethoxysilane into the mixture solution to react for about 3 hours, stirring the mixture solution by a magnetic stir bar, so as to form a sol solution; and finally, standing the sol solution for 15 hours to age the sol solution, so as to form a solution of nano-scale silica gel with a full hydrolyzation and polymerization; and

(4) mixing the solution A of step (2) with the solution of nano-scale silica gel, adding a predetermined amount of benzoyl peroxide into a mixture of the solution A and the solution of nano-scale silica gel, and evenly stirring at the room temperature for 1 hour, so as to form a colorless transparent protection coating, wherein the ratio of the volume of the solution of silica gel and the total volume of the solution A and the solution of silica gel is 5-10:100, and wherein the ratio of the weight of benzoyl peroxide and the total weight of the solution A, the silica gel and benzoyl peroxide is 0.1-0.3:100.

Furthermore, a protection coating manufactured by the foregoing manufacturing method of the present invention is also provided.

Moreover, a use of the foregoing protection coatings comprises the following steps of:

(1) applying the protection coatings onto a surface of a plastic product; and

(2) heating the plastic product applied with the protection coating at 80-100° C. for 0.5-8 hours, so that the protection coatings applied on the surface of the plastic product is solidified to form a transparent protection layer.

A preferred embodiment of the present invention applied to a product made of plastic material is used to further describe the effect of the protection coating hereinafter.

Firstly, mixing tetraethyl orthosilicate (TEOS) with acrylic silane in a mole ratio of 1:1, and evenly stirring at the room temperature for 0.5 hour, so as to obtain an inorganic mixture; then, mixing the inorganic mixture with deionized water and 99.5% ethanol, and continuously stirring at the room temperature for 48 hours, so as to obtain a clear transparent solution, i.e. solution A, wherein the mole ratio of acrylic silane and deionized water is 1:5, and the mole ratio of acrylic silane and the organic solvent is 1:5; afterwards, mixing the solution A with the solution of silica gel and benzoyl peroxide, and evenly stirring at the room temperature for 1 hour, so as to form a colorless transparent protection coating of the present invention, wherein the ratio of the volume of the solution of silica gel and the total volume of the solution A and the solution of silica gel is 5-10:100, and wherein the ratio of the weight of benzoyl peroxide and the total weight of the solution A, the silica gel and benzoyl peroxide is 0.1:100.

Further, applying the protection coating onto a surface of a plastic product by an applying device; and then heating the plastic product applied with the protection coating at 100° C. for 0.5 hour, so that the protection coating applied on the surface of the plastic product is solidified to form a transparent protection layer having a thickness of about 20 μm. The sample of the plastic product is tested by an anti-abrasion test of ASTM D3363 standard, and the hardness of the protection layer on the plastic product is up to 3 H. Meanwhile, the test shows that the abrasion resistance of the transparent protection layer formed by the protection coatings is in direct proportion to the coating thickness. Thus, if the protection layer is thicker, the abrasion resistance thereof is better.

According to results of the foregoing test, the surface of the plastic product applied with the protection coatings of the present invention can provide the higher hardness and the better abrasion resistance.

The foregoing methods of the present invention can be widely applied to various consumer electronics, such as keyboard, mouse, various signal transmission cables, connector, display, disc machine, desktop computer host, notebook computer, mobile phone, earphone, personal digital assistant (PDA), telephone, antenna, television, DVD player, audio, speaker, MP3 player, MP4 player, camera, recorder pen and the likes.

As described above, the manufacturing method of the present invention is simple, while the production environment and conditions thereof is at room temperature and under the atmospheric pressure without any expensive and special reaction equipment. Thus, the mass production can be carried out, and the production cost of the protection coatings can be lowered. As a result, the protection coatings, the manufacturing method and the use thereof of the present invention can provide the foregoing effects by the steps described hereinbefore.

The present invention has been described with preferred embodiments thereof and it is understood that many changes and modifications to the described embodiments can be carried out without departing from the scope and the spirit of the invention that is intended to be limited only by the appended claims.

What is claimed is:

1. A manufacturing method of protection coating, comprising the steps of:
(1) mixing tetraethyl orthosilicate (TEOS) with acrylic silane, and evenly stirring at the room temperature for 0.5-1.5 hours, so as to obtain an inorganic mixture;
(2) mixing the inorganic mixture of step (1) with deionized water and an organic solvent, and continuously stirring at the room temperature for 48-72 hours, so as to obtain a clear transparent solution A;
(3) preparing a solution of nano-scale silica gel by a sol-gel process; and
(4) mixing the solution A of step (2) with the solution of nano-scale silica gel, adding a predetermined amount of benzoyl peroxide into a mixture of the solution A and the solution of nano-scale silica gel, and evenly stirring at the room temperature for 0.5-1 hour, so as to form a colorless transparent protection coatings.

2. The manufacturing method of protection coating according to claim 1, wherein mole ratio of tetraethyl orthosilicate and acrylic silane is 0.5-1:1.

3. The manufacturing method of protection coating according to claim 1, wherein mole ratio of acrylic silane and deionized water is 1:5, and mole ratio of acrylic silane and the organic solvent is 1:5.

4. The manufacturing method of protection coating according to claim 3, wherein the organic solvent is 99.5% ethanol or isopropanol.

5. The manufacturing method of protection coating according to claim 1, wherein silica in the silica gel has a particle size of 8-10 nm.

6. The manufacturing method of protection coating according to claim 1, wherein the ratio of the volume of the solution of silica gel and the total volume of the solution A and the solution of silica gel is 5-10:100, and the ratio of the weight of benzoyl peroxide and the total weight of the solution A, the silica gel and benzoyl peroxide is 0.1-0.3:100.

7. A protection coating, which is manufactured by the manufacturing method of protection coating according to claim 1.

8. A use of the protection coating according to claim 7 comprising the steps of:
(1) applying the protection coatings onto a surface of a plastic product; and
(2) heating the plastic product applied with the protection coatings at 80-100° C. for 0.5-8 hours, so that the protection coatings applied on the surface of the plastic product is solidified to form a transparent protection layer.

9. A protection coating, which is manufactured by the manufacturing method of protection coating according to claim 2.

10. A use of the protection coating according to claim 9 comprising the steps of:
(1) applying the protection coatings onto a surface of a plastic product; and
(2) heating the plastic product applied with the protection coatings at 80-100° C. for 0.5-8 hours, so that the protection coatings applied on the surface of the plastic product is solidified to form a transparent protection layer.

11. A protection coating, which is manufactured by the manufacturing method of protection coating according to claim 3.

12. A use of the protection coating according to claim 11 comprising the steps of:
(1) applying the protection coatings onto a surface of a plastic product; and
(2) heating the plastic product applied with the protection coatings at 80-100° C. for 0.5-8 hours, so that the protection coatings applied on the surface of the plastic product is solidified to form a transparent protection layer.

13. A protection coating, which is manufactured by the manufacturing method of protection coating according to claim 4.

14. A use of the protection coating according to claim 13 comprising the steps of:
(1) applying the protection coatings onto a surface of a plastic product; and
(2) heating the plastic product applied with the protection coatings at 80-100° C. for 0.5-8 hours, so that the protection coatings applied on the surface of the plastic product is solidified to form a transparent protection layer.

15. A protection coating, which is manufactured by the manufacturing method of protection coating according to claim 5.

16. A use of the protection coating according to claim 15 comprising the steps of:
(1) applying the protection coatings onto a surface of a plastic product; and
(2) heating the plastic product applied with the protection coatings at 80-100° C. for 0.5-8 hours, so that the protection coatings applied on the surface of the plastic product is solidified to form a transparent protection layer.

17. A protection coating, which is manufactured by the manufacturing method of protection coating according to claim 6.

18. A use of the protection coating according to claim 17 comprising the steps of:
(1) applying the protection coatings onto a surface of a plastic product; and
(2) heating the plastic product applied with the protection coatings at 80-100° C. for 0.5-8 hours, so that the protection coatings applied on the surface of the plastic product is solidified to form a transparent protection layer.
